(19) United States
(12) Patent Application Publication
(10) Pub. No.: US 2011/0072757 A1
(43) Pub. Date: Mar. 31, 2011

(54) Reuseable Cross Tie System and Arrangements for Concrete Forms

(76) Inventor: Charles W. Westby, Nuiqsut, AK (US)

(21) Appl. No.: 12/310,858

(22) PCT Filed: Nov. 8, 2006
(86) PCT No.: PCT/US2006/043701

§ 371 Date: Nov. 15, 2010

(51) Int. Cl. E04G 21/00; B29C 33/48; B29C 47/58

(52) U.S. Cl. 52/742.15; 249/183; 264/219

(57) ABSTRACT

A wall form tie retrieval system is disclosed that provides a wall form tie casing. The casing can be a channel sized to fit between two assembled concrete wall forms. A lid can be manufactured to fit on the channel to surround the wall form tie when assembled. The wall form tie secures the two concrete wall forms together and the channel can space the forms apart a predetermined distance. The channel can have an open side and a lid to engage the open side of the channel such that placement of the lid substantially encloses the wall tie. After concrete is poured and cured, the wall form tie can be removed from the casing and re-used. The plastic or reinforced paper wall tie casings can be manufactured for a fraction of the cost of the metal ties, thus saving money in the construction of concrete walls.

### CROSS REFERENCE TO RELATED APPLICATIONS

This United States National patent application claims priority to pending International Patent Application having Serial No. PCT/US2006/043701 filed Nov. 8, 2006, entitled “Reuseable Cross Tie System and Arrangements for Concrete Forms”, having a common applicant herewith.

### FIELD OF THE DISCLOSURE

The present disclosure is generally related to concrete wall forms and more particularly to a wall form tie retrieval system.

### BACKGROUND

Each year construction workers form and pour millions of feet of concrete walls. A typical concrete wall form system is modular, where panels are assembled to one another. These panels face each other and a series of cross ties, ties, or form clips are placed to secure the forms together. Tying the two forms securely together is important because when heavy concrete is poured into the form, a significant amount or pressure is placed on the face of the form and ties can prevent the wall forms from bowing or separating during the pour operation. If the wall form bows, then the resulting wall would have unsightly waves and excess concrete would be expended. In conventional wall forming systems these metal ties that secure the opposing wall forms become part of the wall after the concrete hardens. Thus, ties are inserted through each wall form, fastened on each side of the wall form and act in tension to keep the walls from parting or bowing during the pour. Since the ties run between the wall forms and the concrete is poured in this area, the ties become surrounded on all sides with concrete and when the forms are removed the clips protrude from the cured wall and are typically broken off flush with the wall with a hammer or cutting device. Thus, in an average home that has a basement, hundreds of ties will be consumed on the project. Ties are commonly fabricated from steel and can cost over a dollar a piece. Thus, in a hundred feet of poured wall the cost of disposable ties can be as hundreds of dollars. Accordingly, there is a need for a way to reduce the cost of disposables in the manufacture of concrete walls.

### BRIEF DESCRIPTION OF THE DRAWINGS

FIG. 1 is an orthogonal drawing of a concrete wall form with a tie retrieval system; and

FIG. 2 is an orthogonal view of a retrieval casing.

### DETAILED DESCRIPTION OF THE DRAWINGS

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, methods and arrangements for a retrieving wall form ties is provided herein. While specific embodiments will be described below with reference to a particular embodiment, those of skill in the art will realize that embodiments may advantageously be implemented with other configurations.

A wall form tie retrieval system is disclosed that provides a wall form tie casing. The casing can be a channel with a lid sized to fit between two assembled concrete wall forms. The wall form tie secures the two concrete wall forms together and can space the forms apart a predetermined distance. The channel can have an open side and the lid can engage the open side of the channel such that placement of the lid substantially encloses the wall tie. After concrete is poured and cured, the wall form tie can be removed from the casing and re-used. The plastic or reinforced paper wall tie casings can be manufactured for a fraction of the cost of the metal ties, thus saving money in the construction of concrete walls.

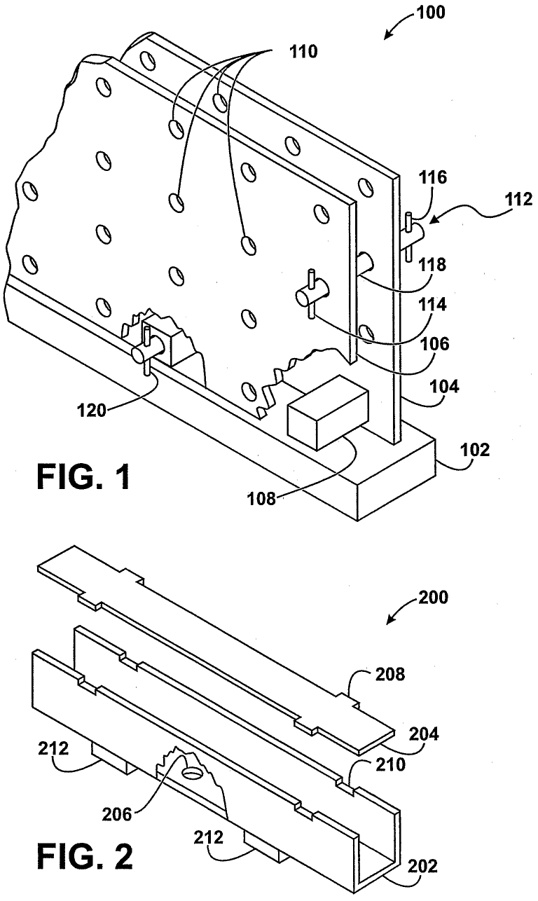

Referring to FIG. 1 a typical wall forming system 100 is depicted. In the construction of a concrete wall, a footing 102 will typically be formed and poured first. Then, after the footing cures, wall forms 104 and 106 will be brought in and assembled on top of the footing 102. Wall forms 104 and 106 typically have opposing holes 110 that will line up when forms 104 and 106 are placed into position. Cross ties, ties or clips such as tie 112 can be placed through the holes in each form 104 and 106 and a fastener 114 and fastener 116 can be placed on the end of the tie 112 to secure the tie 112 to the wall 106. Tie 112 can have a spacer 118 that keeps the wall forms 104 and 106 spaced apart the appropriate distance. Alternately, tie casing 108 can space the forms 104 and 106 apart a predetermined distance.

In accordance with the present disclosure, a tie casing 108 can be placed around a tie, such as tie 120 such that after the concrete is poured between wall forms 104 and 106, the tie 120 can be removed and reused in another job. A tie casing can be a shell, a structure, a housing, or a covering that envelops the wall tie 120. Wall tie 112 can be round, square, or a thin strip of steel material as wall ties of all shapes could be accommodated by the tie casing 108.

A metal tie 112 can cost over a dollar when purchased. The tie casing 108 can be manufactured from a tarred paper or an inexpensive plastic wherein the cost to manufacture the tie casing 108 can be less than ten cents each. Generally, tie casing 108 allows the ties such as tie 112 to be easily removed after the concrete cures within the form. Thus, hundreds of dollars can be saved during construction of a single concrete wall.

Referring to FIG. 2 an orthogonal view of a tie casing 200 is depicted. Tie casing 200 can be a two piece design having a U shaped member or channel 202 and a lid 204 to form a box when assembled. In another embodiment, the tie casing 200 can be manufactured as a single piece where a flexible plastic hinge attaches the lid 204 to the channel 202 and a plastic latch (not shown) can hold the lid 204 down to the channel 120 to form a box. In a particular embodiment, the lid 204 can have tabs 208 and the channel 202 can have grooves or tab receivers 210 such that when the tie casing 200 is assembled around the tie, the lid 204 can be secured to the open side of the channel 202.

The tie casing 200 can be made from plastic and can be injection molding or it can be extruded. Many different materials could be utilized such as polyethylene, polypropylene and Acrylonitrile, butadiene and styrene (ABS) and even recycled plastic. In a particular embodiment tie casing 200 could be made from a thick waxy paper or tar paper or from recycled, compressed glued cardboard or paper. This embodiment can include plant fibers made rigid by some binding material that sets up in a rigid manner, such as glue.

In one embodiment a hole 206 can be placed in the channel 202 to assist in securing the channel 202 to the footing prior to pouring the wall. In this manner the tie casing 200 can stay in position during the pour and make it easier for the tie to be removed when the concrete has cured. In another embodiment an adhesive 212 such as a construction glue or double sided tape can be utilized to fasten tie casing 200 to the footing.

The tie casing 200 could be made in varying lengths based on the dimension between the forms. The tie casing 200 could also come in eight foot lengths and be cut at the job site to the desired length. The majority of pored walls are six inches thick however, eight and twelve inch walls are also common.

The tie casings 200 can be utilized for tie locations wherever desired but are useful at the bottom of the forms. The utilization of inexpensive tie casings 202 as a disposable instead of relatively expensive metal ties is a cost effective approach to building formed walls. An additional feature provided by the tie casing 200 is that after the wall cures the through holes provided can be utilized as drain holes, as conduit for stringing wires and for a drain on water pipes. If the through holes are not going to be utilized, the holes can be filled with patching concrete or some other material.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wall form tie retrieval system comprising;
a channel configured to insert between two concrete wall forms and to case a wall form tie placed between the two concrete wall forms, the channel having an open side; and
a lid adapted to engage the channel on the open side such that placement of the lid substantially encloses the wall form tie, wherein after concrete is poured and cured the wall form tie can be removed from the casing.

2. The wall form tie retrieval system of claim 1 wherein the lid comprises tabs.

3. The wall form tie retrieval system of claim 2 wherein the channel comprises tab receivers adapted to receive the tabs of the lid.

4. The wall form tie retrieval system of claim 1 wherein the channel comprises plastic.

5. The wall form tie retrieval system of claim 1 wherein the channel comprises a fiber material and a binder.

6. The wall form tie retrieval system of claim 1 further comprising a hinge to attach the lid to the channel.

7. The wall form tie retrieval system of claim 1 further comprising an adhesive strip on an underside of the channel to secure the channel to a footing.

8. The wall form tie retrieval system of claim 1 further comprising a hole in an underside of the channel adapter to secure the channel to a footing.

9. The wall form tie retrieval system of claim 1 wherein the channel spaces the first wall form from the second wall form.

10. A method for manufacturing a wall tie casing comprising;
forming a channel having an inside dimension adapted to cover three sides of a wall tie, the channel having tab receivers; and
forming a lid adapted to cover a fourth side of the channel, the lid having tabs to engage the tab receivers.

11. The method of claim 10 further comprising extruding the channel.

12. The method of claim 10 further comprising molding the channel.

13. The method of claim 10 further comprising forming the channel from a paper based material.

14. The method of claim 10 further comprising forming the channel from a paper based fiber and a binding material.

15. The method of claim 10 further comprising cutting the channel into lengths that will fit between wall forms having standard spacings.

16. The method of claim 10 placing a hinge between the lid and the channel.

17. The method of claim 10 further comprising fabricating a latch to fasten the lid to the channel.

18. A method of reusing a wall form tie comprising:
placing at least one tie casing on a footing;
placing concrete forms on the footing;
inserting a wall tie through the forms and the casing;
pouring concrete; and
removing the wall tie when the concrete has cured.

19. The method of claim 18 further comprising assembling the casing around the wall tie.

20. The method of claim 18, wherein assembling the casing comprises assembling a lid on a channel to form an enclosure.
